(19) United States
(12) Patent Application Publication
(10) Pub. No.: US 2013/0158151 A1
(43) Pub. Date: Jun. 20, 2013

(54) GELS FROM POLYSTYRENE-BASED PHOTOINITIATORS

(71) Applicants: Christian B. Nielsen, Copenhagen (DK); Niels Jørgen Madsen, Alleroed (DK); Bo Rud Nielsen, Alleroed (DK)

(72) Inventors: Christian B. Nielsen, Copenhagen (DK); Niels Jørgen Madsen, Alleroed (DK); Bo Rud Nielsen, Alleroed (DK)

(73) Assignee: COLOPLAST A/S, Humlebaek (DK)

(21) Appl. No.: 13/701,716

(22) PCT Filed: Jun. 1, 2011
(86) PCT No.: PCT/DK2011/050188

§ 371 Date: Feb. 12, 2013

(30) Foreign Application Priority Data
Jun. 1, 2010 (DK) PA 2010 70234
Oct. 1, 2010 (DK) PA 2010 70425
Jan. 24, 2011 (DK) PA 2011 70037
Jan. 24, 2011 (DK) PA 2011 70038

(51) Int. Cl. C09D 125/18; C09D 171/02

(52) U.S. Cl. CPC C09D 125/18; C09D 171/02
USPC 522/35

(57) ABSTRACT

The invention provides a method for the manufacture of a gel precursor. The method comprising the steps of combining a polymeric photoinitiator of the general formula (I): with one or more gel-forming polymers and/or gel-forming monomers to form a matrix composition, and curing the matrix composition obtained in the first step by exposing it to UV radiation. The invention also relates to the gel precursor itself, a method for the manufacture of a hydrophilic gel, the hydrophilic gel itself and a medical device comprising or coated with said gel.

### FIELD OF THE INVENTION

The present invention relates to polymeric photoinitiators based on polystyrene backbones and their use in the production of hydrophilic gels. The invention relates to methods for manufacturing hydrophilic gels and gel precursors using said polymeric photoinitiators, and the hydrophilic gels and gel precursors thus obtained. Medical devices comprising said hydrophilic gels and gel precursors are also provided.

### BACKGROUND OF THE INVENTION

Curing of coatings through ultraviolet (UV) radiation, thereby resulting in a coating with application as a gel (e.g. a hydrogel), requires efficient methods of initiating the chemical reaction responsible for the curing process. Cross-linking of polymeric material through generation of radical species upon irradiation with UV light is widely used to produce hydrogels for medical device coatings. Coating compositions with polyvinylpyrrolidone and a photoinitiator as the main constituents, which are cured with UV irradiation, are often used for producing hydrogels. The photoinitiators used in these processes can be either oligomeric or polymeric. Oligomeric photoinitiators are partially free to diffuse to the surface of the cured material, thereby rendering these substances exposed to the environment.

WO 2008/012325 and WO 2008/071796 describe photocuring of plastic coatings, and mention photoactive benzophenones.

CN 1 974 607 and GB 1 147 250 disclose polystyrene-derived photoinitiators.

### OBJECT OF THE INVENTION

It is an object of the invention to provide a method for the manufacture of gel precursors and hydrophilic gels, and the gel precursors and hydrophilic gels themselves. The photoinitiators can be a component of, or constitute the entire hydrophilic gel.

### SUMMARY OF THE INVENTION

It has been found by the present inventors that polymeric photoinitiators with certain structures can be used in the formation of hydrophilic gels and precursors thereof.

The present invention therefore relates to a method for the manufacture of a hydrophilic gel precursor, i.e. a precursor to a hydrophilic gel, said method comprising the steps of:
a. combining a polymeric photoinitiator of the general formula I:

R₁(A₁)_{q}-{-CH₂CH(Ph(A₂¹)ₙ_{₁}(A₂²)ₙ_{₂}(A₂³)ₙ_{₃}(A₂⁴)ₙ_{₄}(A₂⁵)ₙ_{₅})-}ₚ-R₄(A₃)ᵣ (I)
with one or more gel-forming polymers and/or gel-forming monomers to form a matrix composition, and
b. curing the matrix composition obtained in step a. by exposing it to UV radiation.

In the above formula (I), R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, polyethylenes, polyethylene oxides, polyvinyl pyrrolidones, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group;

n₁, n₂, n₃, n₄, and n₅ are real numbers from 0 to 5, whereby the sum n₁+n₂+n₃+n₄+n₅ is a real number greater than 0;

p is an integer from 1-10,000;

q and r are each an integer from 0-10,000;

A₁ and A₃ are identical or different photoinitiator moieties;

Ph is an optionally-substituted phenyl group; and

A²₁, A²₂, A²₃, A²₄ and A₂⁵—together with Ph—independently form optionally-substituted alkylphenone moieties or optionally-substituted benzophenone moieties;

The invention also provides a hydrophilic gel precursor obtainable via the above method.

The invention provides two methods for the manufacture of a hydrophilic gel. The first method comprises steps a. and b. as set out above, and the further step of:
c. exposing the matrix composition to a swelling medium

wherein step c. may take place before or after step b.

The second method (so-called “auto-curing”) comprises the steps of:
a. providing a polymeric photoinitiator of the general formula I (above)
b. exposing the polymeric photoinitiator from step a. to UV radiation, and
c. exposing the polymeric photoinitiator to a swelling medium

wherein steps b. and c. may take place in any order.

The invention also relates to a hydrophilic gel, obtainable via the above methods.

In the case where the swelling medium is water, a hydrogel is obtained.

Further aspects of the invention include a medical device comprising the hydrophilic gel or gel precursor of the invention, a medical device coated on at least a surface portion thereof with the hydrophilic gel or gel precursor of the invention and the use of a photoinitiator, of the general formula I as defined herein, in the manufacture of a hydrophilic gel or gel precursor.

### LEGENDS TO THE FIGURES

FIG. 1 illustrates a general motif of polymeric photoinitiators, with photoinitiator moieties pendant on a polymeric backbone.

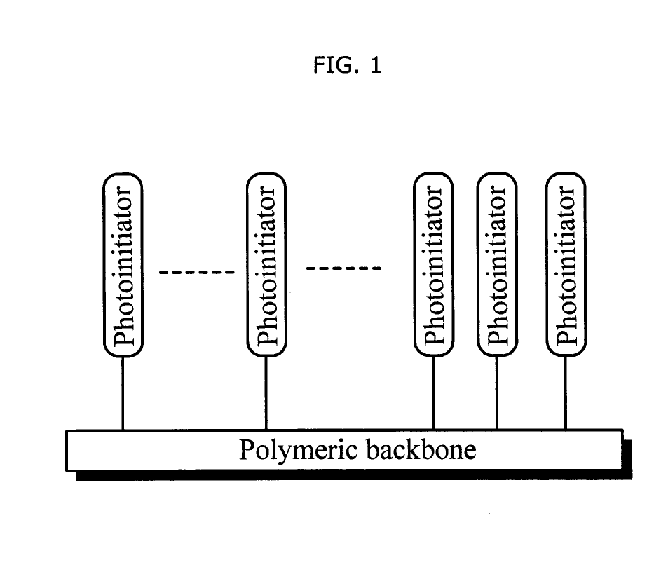

FIG. 2(a) ¹H-NMR(CDCl₃, 500 MHz, 300 K) spectrum (only the aromatic region is shown) of the polymeric photoinitiator 7. (b) TOCSY spectrum of polymeric photoinitiator 7 recorded by irradiating at 7.37 ppm with a mixing time of 100 ms. The signals observed above 7.2 ppm are ascribed to the benzene ring not directly attached to the polymeric backbone. Residual “bleeding” of this spin-system into to the benzene ring attached to the polymeric backbone is indicated with an arrow. (c) TOCSY spectrum of polymeric photoinitiator 7 recorded by irradiating at 6.98 ppm with a mixing time of 100 ms. The signals observed below 7.2 ppm are ascribed to the benzene ring directly attached to the polymeric backbone. Residual “bleeding” of this spin-system into to the benzene ring not attached to the polymeric backbone is indicated with an arrow.

FIG. 3 Mechanical properties of pure PEO, a blend of PEO and 0.4 wt % of 7, and a blend of PEO and 0.4 wt % of 1. (a) Loss and storage modulus of the different blends as a function UV irradiation time. (b) Complex viscosity of the different blends as a function UV irradiation time. (c) Loss factor of the different blends as a function UV irradiation time.

FIG. 4: UV-Vis spectrum of 1 in dichloromethane.

FIG. 5: Schematic illustration of the method(s) of the invention.

### DETAILED DISCLOSURE OF THE INVENTION

Definitions

“Optionally-substituted” means optionally-substituted with one or more substituents selected from the group consisting of C1-C25 linear, branched or cyclic alkyl, aryl, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates. Preferably the one or more substituents are selected from the group consisting of —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates. Most preferably, the substituent is selected from the group consisting of —OH, —CN, halogens, amines, amides, alcohols, ethers, thioethers, sulfones and derivatives thereof, sulfonic acid and derivatives thereof, and sulfoxides and derivatives thereof.

Hydrophilic

A material is described as hydrophilic if it has a natural affinity to water. Hydrophilic materials are defined as those which have a contact angle with water of less than 90°, preferably less than 80°, more preferably less than 75° and most preferably less than 50° (see ASTM D7334-08) measured with an advancing contact angle measurement. In short, the method for measuring the advancing contact angle of a water drop on a surface, is done by deposition of the water droplet (˜5-20 μL) controlled in size within 0.1 μL using a hypodermic syringe. A goniometer is then adjusted such that the interior angle of each of the two points of contact of the drop can be determined. Two angle measurements (one on each drop edge) of three drops on the specimen is determined and the contact angle for the specimen is the average of these six angle measurements.

A hydrophilic polymer is likely to contain atoms with high electronegative values such as oxygen and nitrogen. Materials which are hydrophilic according to the above definition will also have an affinity for alcohols and glycerol. Specific examples of hydrophilic polymers are polyethylene oxides, polyvinylacetates, polyvinylpyrolidones, amine functional polymers e.g. poly(2-ethyl-2-oxazoline), acrylics, polyethers, polystyrenesulfonate, polyvinyl alcohols.

Hydrophilic Gels

A gel is a interconnected, rigid network with pores of submicrometer dimensions and polymeric chains whose average length is greater than a micrometer. The term “gel” is discussed in detail in Flory, P. J. Principles of Polymer Chemistry; Cornell University Press: Ithaca, N.Y., 1953; Chapter IX.

A definition of a gel is provided in Polymer Gels and Networks, 1 (1993), 5-17: A gel is a soft, solid or solid-like material of two or more components one of which is a liquid, present in substantial quantity. Solid-like gels are characterized by the absence of an equilibrium modulus, by a storage modulus, G′(ω), which exhibits a pronounced plateau extending to times at least of the order of seconds, and by a loss modulus, G″(ω), which is considerably smaller than the storage modulus in the plateau region.

In the interest of characterizing the efficiency of a photoinitiator in cross-linking polymeric matrices, the transition from a liquid to a solid material is of importance. Liquids are characterized by having G″(ω)>G′(ω) and correspondingly, solids are characterized by G″(ω)<G′(ω). The transition from liquid to solid, often referred to as the gel-point, is defined as when G″(ω)=G′(ω). The cure time defined as the time from initiation of a curing process to when G″(ω)=G′(ω) or tan δ=1 is a characteristic measure of the efficiency of a photoinitiator in a specific matrix composition.

### Specific Embodiments of the Invention

The present invention provides novel hydrophilic gels and gel precursors, and methods for their manufacture.

The invention provides a method for the manufacture of a hydrophilic gel precursor, i.e. a precursor to a hydrophilic gel. The method comprises the step of: a. combining a polymeric photoinitiator of the general formula I:

$${{R}_{1} ( {A}_{1} )}_{q} - {\{ {—CH}_{2} CH ( {Ph ( {A}_{2}^{1} )}_{{n}_{1}} {( {A}_{2}^{2} )}_{{n}_{2}} {( {A}_{2}^{3} )}_{{n}_{3}} {( {A}_{2}^{4} )}_{{n}_{4}} {( {A}_{2}^{5} )}_{{n}_{5}} ) - \}}_{p} - {{R}_{4} ( {A}_{3} )}_{r} \qquad ( I )$$

with one or more gel-forming polymers and/or gel-forming monomers to form a matrix composition. The invention also relates to the gel precursor formed via this method. Migration of the UV active substances to the surface of the hydrophilic gel is diminished when polymeric photoinitiators are used as opposed to lower molecular weight photoinitiators.

R₁ and R₄ are each independently selected from C1-C25 linear alkyl, C3-C25 branched alkyl, C3-C25 cycloalkyl, aryl, heteroaryl, hydrogen, —OH, —CN, halogens, amines (e.g. —NR′R″, where R′ and R″ are alkyl groups, suitably C1-C25 alkyl groups), amides (e.g. —CONR′R″ or R′CONR″—, where R′ and R″ are alkyl groups, suitably C1-C25 alkyl groups), alcohols, ethers, thioethers, sulfones and derivatives thereof, sulfonic acid and derivatives thereof, sulfoxides and derivatives thereof, carbonates, isocyanates, nitrates, acrylates. Furthermore, R₁ and R₄ can be selected from polymeric entities such as polyacrylates, polyethylenes, polypropylenes, polyethylene oxides, polyvinyl pyrrolidones, polyesters, polyamides and polyurethanes. Of these, polyacrylates, polyethylene oxides, polyvinyl pyrrolidones, polyesters, polyamides and polyurethanes are preferred. The molecular weight of said polymeric entities is typically in the range of 50-5,000 Da. Typically, R₁ and R₄ are each independently selected from C1-C25 linear alkyl, C3-C25 branched alkyl and C3-C25 cycloalkyl.

R₁ and R₄ can be selected from any alkyl group having up to 25 carbon atoms and include both branched and straight chain alkyl groups. Exemplary, non-limiting alkyl groups include methyl, ethyl, propyl, butyl, pentyl, hexyl, heptyl, octyl, nonyl, in the normal, secondary, iso and neo attachment isomers. Exemplary, non-limiting cycloalkyl groups include cyclopropyl, cyclobutyl, cyclopentyl and cyclohexyl.

R₁ and R₄ can also be selected from aryl or heteroaryl groups, such as any aromatic hydrocarbon with up to 20 carbon atoms. Exemplary, non-limiting aryl groups include phenyl, naphthyl, selenophenyl, and tellurophenyl. Exemplary, non-limiting heteroaryl groups include furanyl, thiophenyl, and pyrrolyl.

When R₁ and R₄ are alkyl and aryl groups, they may be substituted with one or more substituents selected from CN; OH; azides; esters; ethers; amides (e.g. —CONR′R″ or R′CONR″—, where R′ and R″ are alkyl groups, suitably C1-C25 alkyl groups); halogen atoms;

sulfones; sulfonic derivatives; NH₂ or Nalk₂, where alk is any C₁-C₈ straight chain alkyl group, C₃-C₈ branched or cyclic alkyl group;

n₁, n₂, n₃, n₄, and n₅ are real numbers from 0 to 5, whereby the sum n₁+n₂+n₃+n₄+n₅ is a real number greater than 0. Suitably, the sum n₁+n₂+n₃+n₄+n₅ is 1. The sum of n₁+n₂+n₃+n₄+n₅ may be 2.

In the above formula (I), p is an integer from 1-10,000. p is suitably an integer from 1-5000, preferably 1-2000.

In the above, q and r are each an integer from 0-10,000; q and r may each be an integer from 0-5000, preferably 0-2000.

The indices p, q and r in the general formula I represent an average/sum and the formula I thereby represents alternating, periodic, statistical/random, block and grafted copolymers. As an example of a random copolymer, may be the copolymer ABAAABABBABA having the formula A₇B₅ according to the nomenclature of formula I.

Further details of the invention are set out in the dependent claims.

An example of the identity of formula I applied to a photoinitiator described in the present invention is given in Scheme 1.

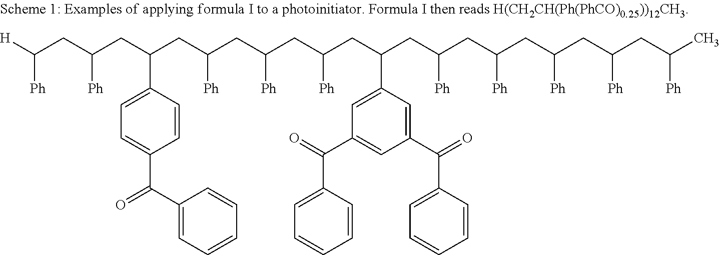 [SMILES: CC(CC(CC(CC(CC(CC(CC(CC(CC(CC(CC(CCc1ccccc1)c1ccccc1)c1ccc(C(=O)c2ccccc2)cc1)c1ccccc1)c1ccccc1)c1ccccc1)c1cc(C(=O)c2ccccc2)cc(C(=O)c2ccccc2)c1)c1ccccc1)c1ccccc1)c1ccccc1)c1ccccc1)c1ccccc1]

Additionally, A₁ and A₃ are identical or different photoinitiator moieties. A₁ and A₃ may be identical or different photoinitiator moieties selected from the group consisting of benzoin ethers, phenyl hydroxyalkyl ketones, phenyl aminoalkyl ketones, benzophenones, thioxanthones, xanthones, acridones, anthraquinones, fluorenones, dibenzosuberones, benzils, benzil ketals, α-dialkoxy-acetophenones, α-hydroxy-alkyl-phenones, α-amino-alkyl-phenones, acyl-phosphine oxides, phenyl ketocoumarins, silanes, maleimides and derivatives thereof. The groups can also consist of derivatives of the photoinitiator moieties listed.

A²₁, A²₂, A²₃, A²₄ and A₂⁵ are selected such that Ph((A₂¹)ₙ_{₁}(A₂²)ₙ_{₂}(A₂³)ₙ_{₃}(A₂⁴)ₙ_{₄}(A₂⁵)ₙ_{₅}) form optionally-substituted alkylphenone moieties or optionally-substituted benzophenone moieties, when at least one of the indicies n₁, n₂, n₃, n₄, and n₅ is different from zero. The nomenclature Ph((A₂¹)ₙ_{₁}(A₂²)ₙ_{₂}(A₂³)ₙ_{₃}(A₂⁴)ₙ_{₄}(A₂⁵)ₙ_{₅}) thus means that there are on average n₁ substitutents placed on the benzene ring of Ph in the polymer chain, there are on average n₂ substitutents on the benzene ring of Ph, and so on. As shown in Formula (I), the photoinitiator moieties are pendant on the polystyrene backbone.

A₁, A₃, A₂¹, A₂², A₂³, A₂⁴ and A₂⁵ are selected independently of one another. In addition, within the repeating polystyrene moiety, substitution with A₂¹, A₂², A₂³, A₂⁴ and A₂⁵ may vary. This means that certain styrene units may comprise one or more optionally-substituted alkylphenone moieties while others may comprise one or more optionally-substituted benzophenone moieties. For ease of synthesis, A₂¹, A₂², A₂³, A₂⁴ and A₂⁵ are the same.

Ph is an optionally-substituted phenyl group; i.e. the functionality C₆H₅—. In other words, the repeating unit is based around polystyrene.

Importantly, A₂¹, A₂², A₂³, A₂⁴ and A₂⁵—together with Ph—independently form optionally-substituted alkylphenone moieties or optionally-substituted benzophenone moieties.

In one aspect, A₂¹, A₂², A₂³, A₂⁴ and A₂⁵—together with Ph—independently form unsubstituted benzophenone moieties, i.e. -Ph-CO-Ph. This is also illustrated in Scheme 1. In particular, Almay be a benzophenone moiety when n₁ is 1 and n₂, n₃, n₄, and n₅ are zero.

In a second aspect, A₂¹, A₂², A₂³, A₂⁴ and A₂⁵—together with Ph—independently form substituted benzophenone moieties. Suitably, at least one electron-withdrawing group is present on A₂¹, A₂², A₂³, A₂⁴ or A₂⁵. At least one electron-withdrawing group may also be present on Ph. The at least one electron-withdrawing group may be selected from the group consisting of halogens, nitriles, carbonyls, nitro groups, sulfones, sulfonamides, sulfonates, trihalides, quarternary amines, amides, sulphonamides, thiocarboxylic acids and thioaldehydes.

In a third aspect, A₂¹, A₂², A₂³, A₂⁴ and A₂⁵—together with Ph—independently form optionally-substituted alkylphenone moieties in which A₂¹, A₂², A₂³, A₂⁴ and A₂⁵ each independently have the structure:

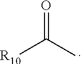

wherein R₁₀ is selected from the group consisting of optionally-substituted C1-C25 linear, branched or cyclic alkyl. R₁₀ may be selected from the group consisting of optionally-substituted C1-C10 linear, branched or cyclic alkyl, preferably optionally-substituted C1-C5 linear or branched alkyl. R₁₀ may be substituted with one or more substituents independently selected from the group consisting of C1-C25 linear, branched or cyclic alkyl, aryl, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates. The substituent on R₁₀ may be selected from the group consisting of —OH, —CN, halogens, amines, amides, alcohols, ethers, thioethers, sulfones and derivatives thereof, sulfonic acid and derivatives thereof, and sulfoxides and derivatives thereof.

The photoinitiator moieties of the invention may independently be cleavable (Norrish Type I) or non-cleavable (Norrish Type II). Suitably, the photoinitiator moieties of the invention are all non-cleavable (Norrish Type II). For reference, see e.g. A. Gilbert, J. Baggott: “Essentials of Molecular Photochemistry”, Blackwell, London, 1991). Upon excitation cleavable photoinitiator moieties spontaneously break down into two radicals, at least one of which is reactive enough to abstract a hydrogen atom from most substrates. Benzoin ethers (including benzil dialkyl ketals), phenyl hydroxyalkyl ketones and phenyl aminoalkyl ketones are important examples of cleavable photoinitiator moieties. Non-cleavable photoinitiator moieties do not break down upon excitation, thus providing fewer possibilities for the leaching of small molecules from the matrix composition. The photoinitiator moieties of the invention are efficient in transforming light from the UV or visible light source to reactive radicals which can abstract hydrogen atoms and other labile atoms from polymers and hence effect covalent cross-linking. Optionally, amines, thiols and other electron donors can be either covalently linked to the polymeric photoinitiator or added separately or both. The addition of electron donors is not required but may enhance the overall efficiency of cleavable photoinitiators according to a mechanism similar to that described for the non-cleavable photoinitiators below.

Excited non-cleavable photoinitiators do not break down to radicals upon excitation, but abstract a hydrogen atom from an organic molecule or, more efficiently, abstract an electron from an electron donor (such as an amine or a thiol). The electron transfer produces a radical anion on the photoinitiator and a radical cation on the electron donor. This is followed by proton transfer from the radical cation to the radical anion to produce two uncharged radicals; of these the radical on the electron donor is sufficiently reactive to abstract a hydrogen atom from most substrates. Benzophenones and related ketones such as thioxanthones, xanthones, anthraquinones, fluorenones, dibenzosuberones, benzils, and phenyl ketocoumarins are important examples of non-cleavable photoinitiators. Most amines with a C—H bond in α-position to the nitrogen atom and many thiols will work as electron donors. The photoinitiator moieties of the invention are preferably non-cleavable.

Self-initiating photoinitiator moieties are within the scope of the present invention. Upon UV or visible light excitation, such photoinitiators predominantly cleave by a Norrish type I mechanism and cross-link further without any conventional photoinitiator present, allowing thick layers to be cured. Recently, a new class of P-keto ester based photoinitiators has been introduced by M. L Gould, S. Narayan-Sarathy, T. E. Hammond, and R. B. Fechter from Ashland Specialty Chemical, USA (2005): “Novel Self-Initiating UV-Curable Resins: Generation Three”, Proceedings from RadTech Europe 05, Barcelona, Spain, Oct. 18-20 2005, vol. 1, p. 245-251, Vincentz. After base-catalyzed Michael addition of the ester to polyfunctional acrylates a network is formed with a number of quaternary carbon atoms, each with two neighbouring carbonyl groups.

Another self-initiating system based on maleimides has also been identified by C. K. Nguyen, W. Kuang, and C. A. Brady from Albemarle Corporation and Brady Associates LLC, both USA (2003): “Maleimide Reactive Oligomers”, Proceedings from RadTech Europe 03, Berlin, Germany, Nov. 3-5, 2003, vol. 1, p. 589-94, Vincentz. Maleimides initiate radical polymerization mainly by acting as non-cleavable photoinitiators and at the same time spontaneously polymerize by radical addition across the maleimide double bond. In addition, the strong UV absorption of the maleimide disappears in the polymer, i.e. maleimide is a photobleaching photoinitiator; this could make it possible to cure thick layers.

So, in an embodiment of the invention, the photoinitiator moieties include at least two different types of photoinitiator moieties. Preferably the absorbance peaks of the different photoinitiators are at different wavelengths, so the total amount of light absorbed by the system increases. The different photoinitiators may be all cleavable, all non-cleavable, or a mixture of cleavable and non-cleavable. A blend of several photoinitiator moieties may exhibit synergistic properties, as is e.g. described by J. P. Fouassier: “Excited-State Reactivity in Radical Polymerisation Photoinitiators”, Ch. 1, pp. 1-61, in “Radiation curing in Polymer Science and technology”, Vol. II (“Photo-initiating Systems”), ed. by J. P. Fouassier and J. F. Rabek, Elsevier, London, 1993. Briefly, efficient energy transfer or electron transfer takes place from one photoinitiator moiety to the other in the pairs [4,4′-bis(dimethyl-amino)benzophenone+benzophenone], [benzophenone+2,4,6-trimethylbenzophenone], [thioxanthone+methylthiophenyl morpholinoalkyl ketone].

Furthermore, it has recently been found that covalently linked 2-hydroxy-1-(4-(2-hydroxyethoxy)phenyl)-2-methylpropan-1-one, which is commercially available with the trade name Irgacure 2959, and benzophenone in the molecule 4-(4-benzoylphenoxyethoxy)phenyl 2-hydroxy-2-propyl ketone gives considerably higher initiation efficiency of radical polymerization than a simple mixture of the two separate compounds, see S. Kopeinig and R. Liska from Vienna University of Technology, Austria (2005): “Further Covalently Bonded Photoinitiators”, Proceedings from RadTech Europe 05, Barcelona, Spain, Oct. 18-20 2005, vol. 2, p. 375-81, Vincentz. This shows that different photoinitiator moieties may show significant synergistic effects when they are present in the same oligomer or polymer. Such covalently linked photoinitiator moieties are also applicable within the present invention.

Each and every one of the above-discussed types of photoinitiators and photoinitiator moieties may be utilised as photoinitiator moieties in the polymeric photoinitiators of the present invention.

Polymeric Photoinitiators of the Invention

Polystyrene Derived Photoinitiators

The polystyrene photoinitiators can be synthesized by grafting phenone moieties onto a polymeric backbone. A general scheme for a synthesis of a polymeric photoinitiator with pendant photoinitiator moieties based on a polystyrene backbone is shown in Scheme 2, where the symbols from the general formula for the polymeric photoinitiators are exemplified. o′ and p′ are integers.

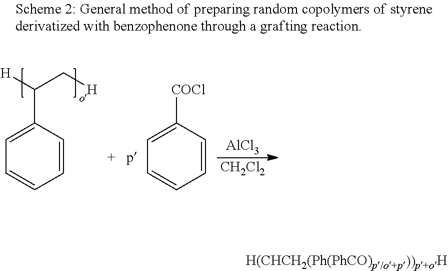

The general method is illustrated in Scheme 2, where a Friedel-Crafts reaction is used to make the benzophenone derivatized polystyrene. This particular procedure has been described previously in K. H. Hong, G. Sun Poly. Eng. Sci., (2007), 1751-1755, where polystyrenes with Mₙ 140.000 were used as reactants.

An alternate route to forming copolymers of styrene and phenyl-(4-vinyl-phenyl)-methanone is by an anionic polymerization of these monomers as illustrated in Scheme 3.

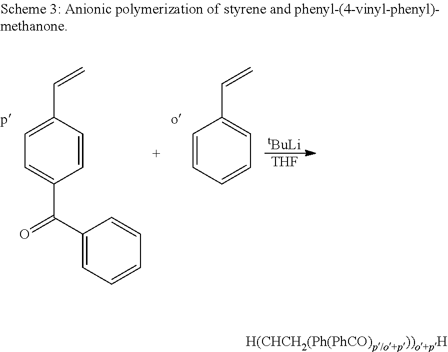

Similar reactions as the ones described above can be used to synthesize polymers with various substituents on the phenyl rings.

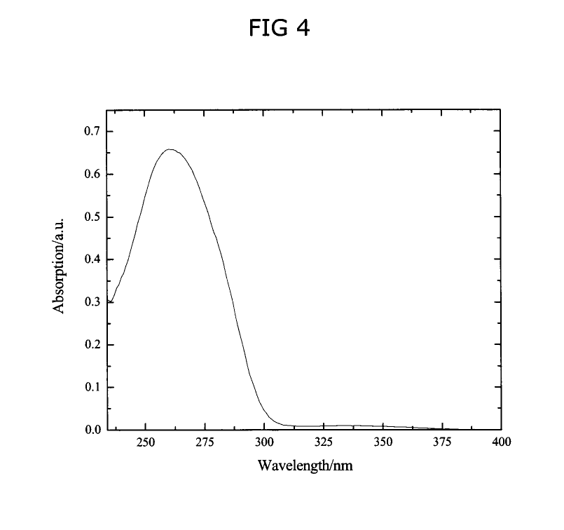

The molecular weight of the polymer synthesized in Scheme 3 is dictated by the molecular weight of the polystyrene used as the reactant. However, the molecular weight of the polymer synthesized in Scheme 3 is dependent on the specific reaction conditions (i.e. temperature, concentration and reaction time). The molecular weight can be measured using a variety of techniques. One method (which is the method used in the examples of the present invention) is to use NMR techniques. Specific resonances, which can be ascribed specifically to benzophenone and styrene moieties, were integrated and compared, thus giving a ratio of how many styrene moieties have been converted to benzophenone in the Friedel-Crafts reaction. The molecular weight (Mw and Mn) of the starting polystyrene can then be used along with this ratio data to calculate the molecular weight of the benzophenone derivitized polystyrene. Alternative methods include gel permeation/size exclusion chromatography (GPC, SEC). Techniques such as mass spectrometry (e.g. MALDI-TOF) and dynamical mechanical analysis can provide measures of the molecular weight. A typical UV-VIS absorption spectrum of the poly-(styrene-co-phenyl-(4-vinyl-phenyl)-methanone) derivatives is shown in FIG. 4, which illustrates that the polymers absorb in the UVC region suitable for curing experiment with a Xenon lamp.

Efficiency of the polymeric photoinitiator is among other things related to how well the photoinitiator is blended with the gel-forming polymer(s) or monomer(s). Amongst important parameters in this respect is the molecular weight of the photoinitiator. A molecular weight which is too high does not allow for good miscibility of the polymeric photoinitiator with other components of the matrix composition. In one embodiment, therefore, the molecular weight of the polymeric photoinitiator is suitably between 0.2 kDa and 100 kDa, suitably between 0.2 kDa and 75 kDa and preferably between 0.5 and 50 kDa. The invention also provides embodiments in which the Mw of the polystyrene is 0.20-30 kDa and the loading is greater than 0% and below 50%. In the present invention, M_{w} (the weight averaged molecular weight) is used to characterize the polymeric photoinitiators.

Important for the present invention is the miscibility of the polymeric photoinitiator with the other components in the matrix composition, when considering a two-component system. In particular, example 1 illustrates that if the chemical nature and molecular weight of the photoinitiator and the polyethyleneoxide are markedly different, a poor miscibility is obtained, which in turn results in a matrix composition that is difficult to cure.

Matrix Composition

As set out above, the polymeric photoinitiators of formula (I) are—in a first method—combined with one or more gel-forming polymers and/or gel-forming monomers to form a matrix composition. Gel-forming polymers are polymers which—due to their hydrophilic nature—after curing, retain a swelling medium such as water within the polymer structure, allowing a hydrophilic gel to be formed, once the matrix composition is cured.

In particular, the gel-forming polymer may be a hydrogel-forming polymer. A hydrogel-forming polymer is selected from the group comprising polyacrylates, polyalkylethers such as polyethylene oxide, polyurethanes, polyamides, polyethylene vinyl acetates, polyvinylpyrrolidone and co-polymers and blends thereof. Preferably the hydrogel-forming polymer is selected from the group consisting of polyalkylethers, polyurethanes, polyethylene vinyl acetate.

A gel-forming monomer is a monomer which produces a gel-forming polymer when polymerised. A hydrogel-forming monomer is one which produces hydrophilic polymers as set out above. Suitable hydrogel-forming monomers may be selected from the group consisting of acrylate monomers, N-vinylpyrrolidone, and epoxide monomers and, for example, monomers with two or more hydroxyl and/or amino functionalities, such as diethanol and aminoethanol.

For providing a gel after a curing step, a polymerization of the monomeric entities occurs in conjecture with cross-linking. After the curing step, the cross-linked composition is then swelled with a swelling medium such as water, C1-C5 alcohols, glycerol and polyethylene glycol (PEG), preferably PEG-2000.

Other possible components in the matrix composition include anti-oxidants such as BHT (2,6-bis(1,1-dimethylethyl)-4-methylphenol), Irganox 1010 (from Ciba) and similar structures. Therapeutic additives are also possible components in the matrix composition. When such additional components are present in the matrix composition, they may be added directly at the same time as the matrix composition is formed, at any point prior to curing, or as a component of the swelling medium. The latter is most preferred.

Curing

The present invention details the cross-linking (curing) of gel-forming polymers or monomers, with curing up to a point where the matrix composition obtains gel properties when exposed to a swelling medium. Curing can either occur in the molten state, or in a solution. The latter comprises steps, where the matrix composition is dissolved in a suitable solvent and for example spray-coated on to a tube, and subsequently exposed to UV radiation. The solvent can afterwards either be evaporated or remain in the coating and function as a swelling medium to provide the desired gel.

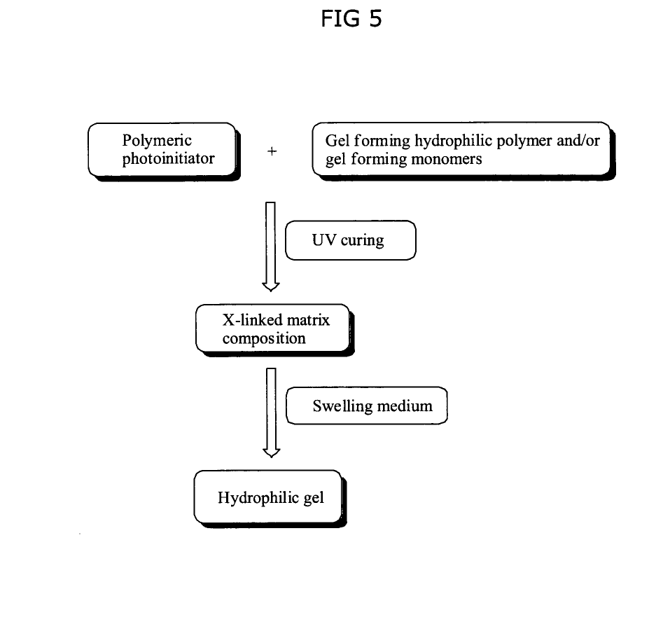

The individual steps of forming gels in a curing process either through solvent coating techniques or by curing a molten matrix composition are exemplified in FIG. 5.

Once the polymeric photoinitiator of the general formula I has been combined with one or more gel-forming polymers and/or gel-forming monomers to form a matrix composition in step a. of the first method of the invention, the matrix composition is cured by exposing it to UV radiation.

The ultraviolet spectrum is divided into A, B and C segments where UV A extends from 400 nm to 315 nm, UV B from 315 to 280 nm, and UV C from 280 to 100 nm. By using a light source that generates light with wavelengths in the visible region (400 to 800 nm) some advantages are obtained with respect to the depth of the curing, provided that the photoinitiator can successfully cure the material at these wavelength. In particular, scattering phenomena are less pronounced at longer wavelength, thus giving a larger penetration depth in the material. Thus photoinitiators which absorb, and can induce curing, at longer wavelength are of interest. By judicially choosing substituents on the aromatic moieties, the absorption spectrum of the polymeric photoinitiator can to some extent be red-shifted, which would then facilitate curing at comparatively greater depths.

Multi-photon absorption can also be used to cure samples using light sources emitting at wavelengths twice or even multiple times the wavelength of light needed for curing in a one-photon process. For example, a composition containing a photoinitiator with an absorption maximum at ˜250 nm could possibly be cured with a light source emitting at ˜500 nm utilizing a two-photon absorption process provided that the two-absorption cross section is sufficiently high. A multi-photon initiated cure process could also facilitate greater spatial resolution with respect to the cured area, exemplified in Nature 412 (2001), 697 where a 3D structure is formed by a two-photon curing process.

In the present invention, curing is primarily initiated by exposing the matrix composition or polymeric photoinitiator to high energy irradiation, preferably UV light. The photoinitiated process takes place by methods described above and which are known per se, through irradiation with light or UV irradiation in the wavelength range from 250 to 500 nm. Irradiation sources which may be used are sunlight or artificial lamps or lasers. Mercury high-pressure, medium pressure or low-pressure lamps and xenon and tungsten lamps, for example, are advantageous. Similarly, excimer, solid stated and diode based lasers are advantageous. Even pulsed laser systems can be considered applicable for the present invention. Diode based light sources in general are advantageous for initiating the chemical reactions.

In the curing process the polymeric photoinitiator transforms the matrix composition, in a chemical process induced by light. A hydrophilic gel precursor is therefore obtainable via the method described above.

Gel-State

To provide the gel of the invention, the matrix composition is exposed to a swelling medium such as water, C1-C5 alcohols, glycerol and polyethylene glycol (PEG), preferably PEG-2000. The compositions are thus swelled to provide a gel. Contact with the swelling medium may take place before or after curing of the matrix composition. The swelling medium may be in its pristine state, or present in combination with other substances, e.g. in a saline solution or a body fluid. Species present in the gaseous state in equilibrium with a significant portion present in their liquid form also constitute a swelling medium. The invention thus provides a method for the manufacture of a hydrophilic gel, said method comprising steps a. and b. above. The method comprises the further step of: c. exposing the matrix composition to a swelling medium. Step c. may take place before or after step b.

A gel is characterized as a swellable material, however, insoluble in the swelling medium. By hydrogel is meant a material comprised mainly of a water soluble or water swellable material. The gel material is characterized in terms of its rheological properties and in its dry state. In particular the storage and the loss modulus are used to characterize the mechanical properties of the materials (T. G. Mezger: “The Rheology Handbook”, Vincentz Network, Hannover, 2006). As described above, curing of a matrix composition is followed by monitoring the change of G′(ω) and G″(ω) as a function of UV exposure time. In the examples used to describe the present invention, a frequency of 1 Hz is used to probe the rheological properties and further the samples were heated to 120° C. during testing.

The invention also relates to a gel obtainable via this method, in particular a hydrogel.

The polymeric photoinitiators described here can both facilitate curing of a surrounding matrix (as above) but since the photoinitiators themselves are polymers, they can also “auto-cure”, meaning that the polymeric photoinitiators can solely constitute a coating composition that is cured upon UV irradiation. As such, the pristine polymeric photoinitiator can be cured to form cross-linked network, or the polymeric photoinitiator can be a constituent in a matrix composition which is subsequently cured to form a cross-linked network. This is particularly relevant when R₁ and R₄ are hydrophilic polymers such as e.g. polyacrylates, polyethylene oxides, polyvinyl pyrrolidones, polyesters, polyamides and polyurethanes. The invention therefore provides a method for the manufacture of a hydrophilic gel, said method comprising the steps of:
a. providing a polymeric photoinitiator of the general formula I:

R₁(A₁)_{q}{-CH₂CH(Ph(A₂¹)ₙ_{₁}(A₂²)ₙ_{₂}(A₂³)ₙ_{₃}(A₂⁴)ₙ_{₄}(A₂⁵)ⁿ_{₅})-}ₚ-R₄(A₃)ᵣ (I)
wherein:
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, polyethylenes, polyethylene oxides, polyvinyl pyrrolidones, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group;
n₁, n₂, n₃, n₄, and n₅ are real numbers from 0 to 5, whereby the sum n₁+n₂+n₃+n₄+n₅ is a real number greater than 0;
p is an integer from 1-10,000;
q and r are each an integer from 0-10,000;
A₁ and A₃ are identical or different photoinitiator moieties;
Ph is an optionally-substituted phenyl group; and
A₂¹, A₂², A₂³, A₂⁴ and A₂⁵—together with Ph—independently form optionally-substituted alkylphenone moieties or optionally-substituted benzophenone moieties;
b. exposing the polymeric photoinitiator from step a. to UV radiation, and
c. exposing the polymeric photoinitiator to a swelling medium
   wherein steps b. and c. may take place in any order.

The “auto-curing” method described above suitably takes place with steps a., b. and c. occurring in alphabetical order, directly after one another (i.e. with no intermediate steps). In one aspect of this “auto-curing” method, the method consists of steps a. b. and c.

A one-component system—as provided by the “auto-curing” method—provides advantages, in that the cured polymeric photoinitiators are thermoplastic. As such, they become more fluid under pressure, making them easier to process. In contrast, for example, cross linked polyvinyl pyrrolidone cannot be extruded.

Details of the polymeric photoinitiator provided for the above method are also applicable to this method.

The swelling medium is suitably selected from the group consisting of water, C1-C5 alcohols, glycerol and polyethylene glycol (PEG), preferably PEG-2000. Most suitably, the swelling medium comprises water, and the hydrophilic gel thus produced is a hydrogel.

In another aspect, the invention provides a matrix composition comprising a polymeric photoinitiator of Formula (I) as defined above, and one or more gel-forming polymers and/or gel-forming monomers. Suitably, the matrix composition comprises a gel-forming polymer which is selected from the group consisting of polyacrylates, polyalkylethers, polyurethanes, polyethylene vinyl acetates, polyvinylpyrrolidone and co-polymers and blends thereof, or a gel-forming monomer which is selected from the group consisting of acrylate monomers, N-vinylpyrrolidone, and epoxide monomers. In a development of this, the matrix composition consists of a polymeric photoinitiator of Formula (I) as defined above, and one or more gel-forming polymers and/or gel-forming monomers—i.e. these are the only two components in the matrix composition.

The matrix composition may be cured by exposure to UV before or after exposure to the swelling medium. If cured first, a “dry”, cured matrix composition is obtained. If exposed to swelling medium first, a hydrophilic gel can be provided in a one-step process, as the curing step takes place in the presence of the swelling medium. In other words, the swelling medium for the hydrophilic gel is the solvent for the curing step. Suitably, step c takes place before step b.

Similarly, in the “auto-curing” method, the polymeric photoinitiator may be cured by exposure to UV before or after exposure to the swelling medium. If cured first, and exposed to swelling medium afterwards, a “dry”, cured polymeric photoinitiator is obtained. If exposed to swelling medium first, a hydrophilic gel can be provided in a one-step process, as the curing step takes place in the presence of the swelling medium. In other words, the swelling medium for the hydrophilic gel is the solvent for the curing step. Suitably, step c takes place before step b. The invention also relates to a hydrophilic gel, obtainable via the methods described herein.

Medical Device

One aspect of the invention provides a medical device comprising the hydrophilic gel or the gel precursor of the invention. The term “medical device” should be interpreted in a fairly broad sense. Suitable examples of medical devices (including instruments) are catheters (such as urinary catheters), endoscopes, laryngoscopes, tubes for feeding, tubes for drainage, endotracheal tubes, guide wires, sutures, cannulas, needles, thermometers, condoms, urisheaths, barrier coatings e.g. for gloves, stents and other implants, contact lenses, extra corporeal blood conduits, membranes e.g. for dialysis, blood filters, devices for circulatory assistance, dressings for wound care, and ostomy bags. Most relevant are catheters, endoscopes, laryngoscopes, tubes for feeding, tubes for drainage, guide wires, sutures, and stents and other implants. Particularly interesting medical devices within the context of the present invention are catheters, such as urinary catheters.

The medical device may be coated on at least a surface portion thereof with the hydrophilic gel or gel precursor described herein. In some embodiments, the hydrophilic gel or gel precursor covers the full (outer) surface of the medical device, and in some other embodiments, only to a part of the surface thereof. In the most relevant embodiments, the hydrophilic gel or gel precursor covers at least a part of the surface (preferably the whole surface) of the medical device that—upon proper use—comes into direct contact with body parts for which the medical device is intended. It may be that the medical device is coated with the gel precursor, and the hydrophilic gel is generated upon contact with liquid—either the bodily fluids of the patient, or an activating solution containing water.

The invention also provides the use of a photoinitiator, of the general formula I as described above, in the manufacture of a hydrophilic gel or gel precursor.

### EXAMPLES

### Example 1

Gels Prepared from Polystyrene Derived Photoinitiators and Polyethylene Oxide

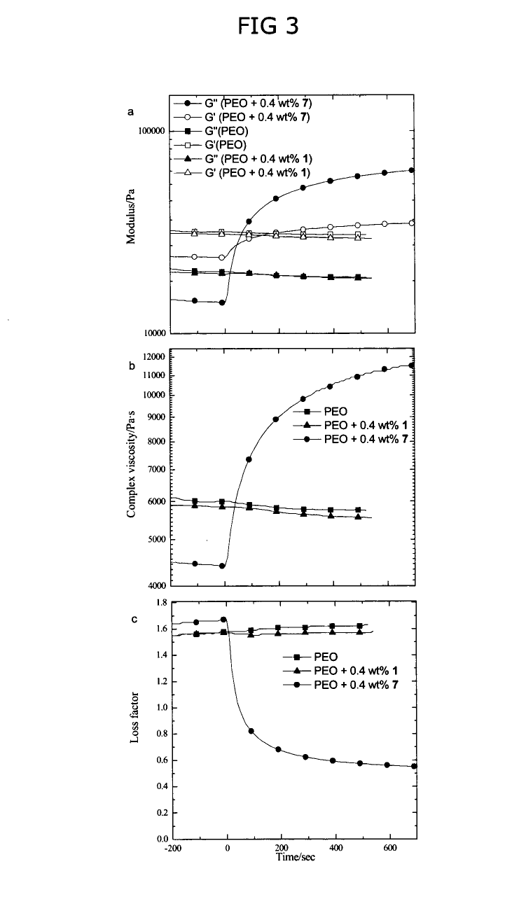

Three different blends were made of polyethylene oxide (PEO-1NF supplied from Sumitomo), benzophenone, poly-(styrene-co-phenyl-(4-vinyl-phenyl)-methanone) and pentaerythriol tetrakis(3-(3,5-di-tert-butyl-4-hydroxyphenyl)-propionate) (tradename Irganox 1010 from Ciba Speciality Chemicals) with compositions as tabulated in Table 1. These blends were made by mixing the components in a twin-screw extruder. The blends were investigated in a rheometer setup, where the melted samples were irradiated with a UV light source and their rheological properties (loss and storage modules) were followed as a function of time. Results from measurements of the samples described above are presented in FIG. 3.

TABLE 1
Compositions of the blends used in the
measurements of mechanical properties.

| | | Polymeric | Irganox |
|---|---|---|---|
| PEO | | photoinitiator | 1010 |
| 99.5% | 0% | | 0.5% |
| 99.1% | 0.4% | 1 | 0.5% |
| 99.1% | 0.4% | 2 | 0.5% |
| 99.1% | 0.4% | 3 | 0.5% |
| 99.1% | 0.4% | 4 | 0.5% |
| 99.1% | 0.4% | 5 | 0.5% |
| 99.1% | 0.4% | 6 | 0.5% |
| 99.1% | 0.4% | 7 | 0.5% |

As a control, a sample of pure PEO without photoinitiator was irradiated and investigated in the rheology experiments and as expected no changes occur in the mechanical properties when exposed to UV light (see FIG. 3(a)-(c)). However, when a photoinitiator with a molecular weight of ˜2400 Da (7) is present in 0.4 wt % in the PEO matrix, the curing process is rapid and a gel state is reached after approximately 1 minute (see FIG. 3(a)-(c)). Increasing the molecular weight of the photoinitiator to ˜192-273 kDa in the blend results in blends that do not cure, i.e. no changes are observed in the mechanical properties as a function of UV exposure (see FIG. 3(a)-(c)). Furthermore, the loss and storage modules of the blends containing 0.4 wt % of the photoinitiator with molecular weights in the range of 192-273 kDa are identical to the modules of the pure PEO sample. This suggests that at these comparatively high molecular weights the photoinitiators are not miscible with the PEO used. This is further confirmed by the opaque nature of the molten samples in contrast to the clear nature of the molten samples containing a photoinitiator with a molecular weight of ˜2400 Da.

### Example 2

### Synthesis of poly-(styrene-co-phenyl-(4-vinyl-phenyl)-methanone)

A series of polymers were made according to the following procedure, where the amount of benzoylchloride was varied to control the content of benzophenone moieties in the polymers: AlCl₃ was put in a round bottom flask and CH₂Cl₂ (200 mL) was added. Benzoylchloride that was dissolved in CH₂Cl₂ (100 mL) was then added and the mixture was stirred at room temperature for 2 h. Polystyrene was then added and the reaction mixture was stirred at room temperature for 24 h. and then poured into a Na—K-tartrate aqueous solution (10 wt %, 500 mL). The quenched reaction mixture was then stirred at room temperature for 3 h. and was filtered. The isolated mixture was transferred to a separatory funnel and the lower yellow phase was isolated, dried with MgSO₄ and filtered again to remove MgSO₄. The solvent was then removed leaving grafted polystyrene. The amount of benzoylchloride and polystyrene used in each synthesis and also the molecular weight of the polystyrene starting material is listed in Table 2.

TABLE 2
Amount and nature of the materials used in the synthesis
of the photoinitiators described in the present work.

| | Polystyrene | | Benzoyl- | | | M_{w}/ |
|---|---|---|---|---|---|---|
| Compound | M_{w}/kDa | Amount/g | chloride/g | AlCl₃/g | Loading | kDa |
| 1 | 192 | 27 | 42.2 | 40 | 42% | 273 |
| 2 | 192 | 27 | 31.6 | 30 | 40% | 269 |
| 3 | 192 | 27 | 21.1 | 20 | 38% | 265 |
| 4 | 192 | 27 | 15.8 | 15 | 28% | 246 |
| 5 | 192 | 27 | 5.30 | 5 | 2% | 196 |
| 6 | 192 | 27 | 1.05 | 1 | ~0% | 192 |
| 7 | 0.20 | 0.47 | 0.68 | 0.68 | 21% | 2.4 |

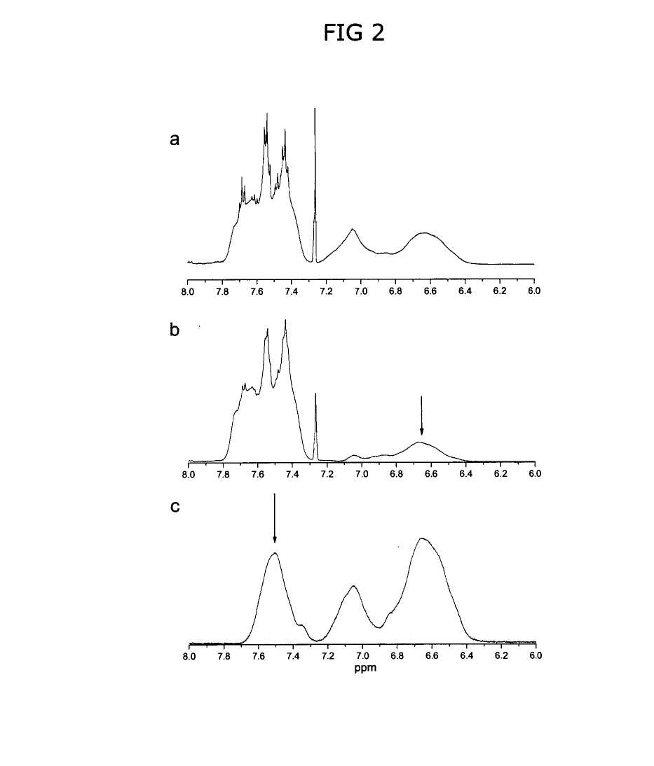

NMR was used to characterize the identity of polymers and to quantify the amount of benzophenone moieties present in the polymer. An example of a ¹H-NMR spectrum (including a TOCSY spectrum) is shown in FIG. 2 and the content of styrene and phenyl-(4-vinyl-phenyl)-methanone present in the polymer is listed in Table 2 along with a calculated molecular weight based on calculations from the NMR data.

### Example 3

Blends of photoinitiator, polyethylene oxide and Irganox 1010 were fabricated by mixing the three components in twin-screw extruder with temperatures set at 100, 106, 111, 120, 140, 140, 140, 140, 76, and 44° C. at the different zones. After the polymer melt had solidified it was granulated and further processed into plates, by hot pressing granulates between Teflon paper pieces at a temperature of 120° C. to a thickness of approximately 1 mm. Oblates with a diameter of 25 mm were cut from these sheets for use in curing experiments.

### Example 4

An oblate was placed between the two plates in a rheometer (parallel plate configuration, bottom plate is a quartz glass plate) and the distance between the plates was set to 0.3 mm and the temperature to 120° C. The measurements were run with fixed strain of 1% and a constant frequency of 1 Hz. When the loss and storage modules had stabilized, a UV-lamp was turned on, thus irradiating the sample through the bottom plate on the rheometer via a fiber from the lamp. The loss and storage modules were then followed as a function of time, while the UV-lamp was irradiating the sample. Illustrative results of the measurements are shown in FIG. 3.

As a control experiment, an oblate containing only PEO was studied using the rheology setup: When the light source is turned on, no changes in the mechanical properties of the pure PEO sample is observed. A similar result is obtained when a high molecular weight polymeric photoinitiator is mixed with the PEO: Upon exposure to UV no changes in rheological properties occurs. That is, no significant changes are observed in either G′ and G″. However, when a polymeric initiator of suitable molecular weight is mixed with PEO-1NF curing does take place as seen in the experiments with 7 as the photoinitiator: When the UV source is turned on, both modulus (G′ and G″) increases in value. G″ increases with a higher rate than G′ which results in a cross-over such that G″ eventually becomes larger than G′, that is tan δ<1. After curing of the sample containing 7 as the photoinitiator thus forming a gel precursor, the sample was placed in water and swelled to form a hydrogel.

1. A method for the manufacture of a hydrophilic gel precursor, said method comprising the steps of:
a. combining a polymeric photoinitiator of the general formula I:
$${{R}_{1} ( {A}_{1} )}_{q} - {\{ {—CH}_{2} CH ( {Ph ( {A}_{2}^{1} )}_{{n}_{1}} {( {A}_{2}^{2} )}_{{n}_{2}} {( {A}_{2}^{3} )}_{{n}_{3}} {( {A}_{2}^{4} )}_{{n}_{4}} {( {A}_{2}^{5} )}_{{n}_{5}} ) - \}}_{p} - {{R}_{4} ( {A}_{3} )}_{r} \qquad ( I )$$
wherein:
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, polyethylenes, polyethylene oxides, polyvinyl pyrrolidones, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group; n₁, n₂, n₃, n₄, and n₅ are real numbers from 0 to 5, whereby the sum n₁+n₂+n₃+n₄+n₅ is a real number greater than 0;
p is an integer from 1-10,000;
q and r are each an integer from 0-10,000;
A₁ and A₃ are identical or different photoinitiator moieties;
Ph is an optionally-substituted phenyl group; and
A₂¹, A₂², A₂³, A₂⁴ and A₂⁵—together with Ph—independently form optionally-substituted alkylphenone moieties or optionally-substituted benzophenone moieties;
with one or more gel-forming polymers and/or gel-forming monomers to form a matrix composition, and
b. curing the matrix composition obtained in step a. by exposing it to UV radiation.

2. The method according to claim 1, wherein A₁ and A₃ are identical or different photoinitiator moieties selected from the group consisting of benzoin ethers, phenyl hydroxyalkyl ketones, phenyl aminoalkyl ketones, benzophenones, thioxanthones, xanthones, acridones, anthraquinones, fluorenones, dibenzosuberones, benzils, benzil ketals, α-dialkoxy-acetophenones, α-hydroxy-alkyl-phenones, α-amino-alkyl-phenones, acyl-phosphine oxides, phenyl ketocoumarins, silanes, maleimides and derivatives thereof.

3. The method according to claim 1, wherein the molecular weight of the polymeric photoinitiator is between 0.2 kDa and 100 kDa, suitably between 0.2 kDa and 75 kDa and preferably between 0.5 and 50 kDa.

4. The method according to claim 1, wherein R₁ and R₄ are each independently selected from C1-C25 linear alkyl, C3-C25 branched alkyl and C3-C25 cycloalkyl.

5. The method according to claim 1, wherein A₂¹, A₂², A₂³, A₂⁴ and A₂⁵—together with Ph—independently form benzophenone moieties.

6. (canceled)

7. The method according to claim 1, wherein A₂¹, A₂², A₂³, A₂⁴ and A₂⁵—together with Ph—independently form substituted benzophenone moieties.

8. The method according to claim 7, wherein at least one electron-withdrawing group is present on A₂¹, A₂², A₂³, A₂⁴ or A₂⁵.

9. The method according to claim 7, wherein at least one electron-withdrawing group is present on Ph.

10. The method according to claim 9, wherein the at least one electron-withdrawing group is selected from the group consisting of halogens, nitriles, carbonyls, nitro groups, sulfones, sulfonamides, sulfonates, trihalides, quarternary amines, amides, sulphonamides, thiocarboxylic acids and thioaldehydes.

11. The method according to claim 1, wherein A₂¹, A₂², A₂³, A₂⁴ and A₂⁵—together with Ph—independently form optionally-substituted alkylphenone moieties in which A₂¹, A₂², A₂³, A₂⁴ and A₂⁵ each independently have the structure 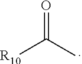
wherein R₁₀ is selected from the group consisting of optionally-substituted C1-C25 linear, branched or cyclic alkyl.

12. The method according to claim 11, wherein R₁₀ is selected from the group consisting of optionally-substituted C1-C10 linear, branched or cyclic alkyl, preferably optionally-substituted C1-C5 linear or branched alkyl.

13. The method according to claim 11, wherein R₁₀ is substituted with one or more substituents independently selected from the group consisting of C1-C25 linear, branched or cyclic alkyl, aryl, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates.

14. The method according to claim 13, wherein the substituent on R₁₀ is selected from the group consisting of —OH, —CN, halogens, amines, amides, alcohols, ethers, thioethers, sulfones and derivatives thereof, sulfonic acid and derivatives thereof, and sulfoxides and derivatives thereof.

15. The method according to claim 1, wherein p is an integer from 1-5000, preferably 1-2000.

16. The method according to claim 1, wherein q and r are each an integer from 0-5000, preferably 0-2000.

17. The method according to claim 1, wherein the sum n₁+n₂+n₃+n₄+n₅ is 1.

18. The method according to claim 1, wherein the gel-forming polymer is selected from the group consisting of polyacrylates, polyalkylethers, polyurethanes, polyethylene vinyl acetates, polyvinylpyrrolidone and co-polymers and blends thereof.

19. The method according to claim 1, wherein the gel-forming monomer is selected from the group consisting of acrylate monomers, N-vinylpyrrolidone, and epoxide monomers.

20. The method according to claim 1, wherein the polymer is a polystyrene and the Mw of the polystyrene is 0.20-30 kDa and the loading is greater than 0% and below 50%.

21. (canceled)

22. A method for the manufacture of a hydrophilic gel, said method comprising steps a. and b. as defined in claim 1, said method comprising the further step of:
c. exposing the matrix composition to a swelling medium wherein step c. may take place before or after step b.

23. A method for the manufacture of a hydrophilic gel, said method comprising the steps of:
a. providing a polymeric photoinitiator of the general formula I:
$${{R}_{1} ( {A}_{1} )}_{q} - {\{ {—CH}_{2} CH ( {Ph ( {A}_{2}^{1} )}_{{n}_{1}} {( {A}_{2}^{2} )}_{{n}_{2}} {( {A}_{2}^{3} )}_{{n}_{3}} {( {A}_{2}^{4} )}_{{n}_{4}} {( {A}_{2}^{5} )}_{{n}_{5}} ) - \}}_{p} - {{R}_{4} ( {A}_{3} )}_{r} \qquad ( I )$$
wherein:
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, polyethylenes, polyethylene oxides, polyvinyl pyrrolidones, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group; n₁, n₂, n₃, n₄, and n₅ are real numbers from 0 to 5, whereby the sum n₁+n₂+n₂+n₄+n₅ is a real number greater than 0;
p is an integer from 1-10,000;
q and r are each an integer from 0-10,000;
A₁ and A₃ are identical or different photoinitiator moieties;
Ph is an optionally-substituted phenyl group; and
A₂¹, A₂², A₂³, A₂⁴ and A₂⁵—together with Ph—independently form optionally-substituted alkylphenone moieties or optionally-substituted benzophenone moieties;
b. exposing the polymeric photoinitiator from step a. to UV radiation, and
c. exposing the polymeric photoinitiator to a swelling medium,
wherein steps b. and c. may take place in any order.

24. The method according to claim 23, wherein the polymeric photoinitiator has the structure defined in claim 1.

25. The method according to claim 23, wherein R₁ and R₄ are selected from the group consisting of polyacrylates, polyethylene oxides, polyvinyl pyrrolidones, polyesters, polyamides and polyurethanes.

26. The method according to claim 22, where the swelling medium is selected from the group consisting of water, C1-C5 alcohols, glycerol and polyethylene glycol (PEG), preferably PEG-2000.

27. The method according to claim 22, where the swelling medium comprises water, and the hydrophilic gel thus produced is a hydrogel.

28. The method according to claim 22, wherein the matrix composition or polymeric photoinitiator is cured after exposure to the swelling medium.

29. The method according to claim 22, consisting of steps a. b. and c.

30. (canceled)

31. A matrix composition comprising a polymeric photoinitiator and one or more gel-forming polymers and/or gel-forming monomers; where the polymeric photoinitiator is of the general formula I:
$${{R}_{1} ( {A}_{1} )}_{q} - {\{ {—CH}_{2} CH ( {Ph ( {A}_{2}^{1} )}_{{n}_{1}} {( {A}_{2}^{2} )}_{{n}_{2}} {( {A}_{2}^{3} )}_{{n}_{3}} {( {A}_{2}^{4} )}_{{n}_{4}} {( {A}_{2}^{5} )}_{{n}_{5}} ) - \}}_{p} - {{R}_{4} ( {A}_{3} )}_{r} \qquad ( I )$$
wherein:
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, polyethylenes, polyethylene oxides, polyvinyl pyrrolidones, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group;
n₁, n₂, n₃, n₄, and n₅ are real numbers from 0 to 5, whereby the sum n₁+n₂+n₃+n₄+n₅ is a real number greater than 0;
p is an integer from 1-10,000;
q and r are each an integer from 0-10,000;
A₁ and A₃ are identical or different photoinitiator moieties;
Ph is an optionally-substituted phenyl group; and
A₂², A₂², A₂³, A₂⁴ and A₂⁵—together with Ph—independently form optionally-substituted alkylphenone moieties or optionally-substituted benzophenone moieties.

32. The matrix composition according to claim 31, wherein the gel-forming polymer is selected from the group consisting of polyacrylates, polyalkylethers, polyurethanes, polyethylene vinyl acetates, polyvinylpyrrolidone and co-polymers and blends thereof.

33. The matrix composition according to claim 31, wherein the gel-forming monomer is selected from the group consisting of acrylate monomers, N-vinylpyrrolidone, and epoxide monomers.

34. (canceled)

35. The medical device according to claim 34, coated on at least a surface portion thereof with the gel.

36. (canceled)

37. The method according to claim 23, where the swelling medium is selected from the group consisting of water, C1-C5 alcohols, glycerol and polyethylene glycol (PEG), preferably PEG-2000.

38. The method according to claim 23, where the swelling medium comprises water, and the hydrophilic gel thus produced is a hydrogel.

39. The method according to claim 23, wherein the matrix composition or polymeric photoinitiator is cured after exposure to the swelling medium.

40. The method according to claim 23, consisting of steps a. b. and c.
